(19) United States
(12) Patent Application Publication
(10) Pub. No.: US 2015/0302402 A1
(43) Pub. Date: Oct. 22, 2015

(54) METHOD FOR AUTHENTICATING A TRANSACTION, AND CORRESPONDING SERVERS, SYSTEMS, DEVICES, COMPUTER-READABLE STORAGE MEDIUMS AND COMPUTER PROGRAMS

(71) Applicant: MasterCard International Incorporated, Purchase, NY (US)

(72) Inventor: William CHAN Chi Yuen, Kowloon (HK)

(21) Appl. No.: 14/688,773

(22) Filed: Apr. 16, 2015

(30) Foreign Application Priority Data
Apr. 17, 2014 (SG) 10201401620V

(51) Int. Cl. G06Q 20/38; G06Q 20/40

(52) U.S. Cl. CPC G06Q 20/3829; G06Q 20/40; G06Q 20/4018

(57) ABSTRACT

Various embodiments provide a method for authenticating a transaction, the method comprising: generating a first authentication code based on transaction information and a first cryptographic key, the transaction information relating to the transaction; providing a data carrier having data comprising the first authentication code and the transaction information; presenting the data carrier to a first server to cause the first server to extract the data from the data carrier; generating a second authentication code based on a second cryptographic key and the transaction information from the extracted data; and authenticating the transaction based on a comparison between the first authentication code from the extracted data and the second authentication code.

### CROSS-REFERENCE TO RELATED APPLICATIONS

This application claims foreign priority to Singapore Patent Application No.: 10201401620V Filing Date: 17 Apr. 2014, the complete disclosure of which is expressly incorporated herein by reference in its entirety for all purposes.

### TECHNICAL FIELD

Various embodiments of the present invention relate to a method for authenticating a transaction and corresponding servers, systems, devices, computer-readable storage mediums and computer programs. In an embodiment, authentication is performed in accordance with the dynamic Card Validation Code (dCVC3) standard.

### BACKGROUND

A transaction may be between two parties, for example, a merchant and a customer. The transaction may involve an exchange of the merchant's goods and/or services for a payment from the customer. A transaction may be performed when the merchant and customer are together, for example, in a shop. Additionally, a transaction may be performed when the merchant and customer are separated, for example, in the case of an e-commerce transaction.

When the parties to a transaction are separated, there is a need to authenticate the transaction before deciding whether or not to authorize the transaction. During the authentication process, a check may be performed to determine whether or not the person providing the bank account details is entitled to use that bank account. During the authorization process, a check may be performed to determine if the bank account has sufficient funds or credit to make the payment. Authorization may be performed only if authentication is successful.

It is known to provide a dynamic code for the purposes of authentication. For example, dCVC3 codes are provided for the purposes of authenticating contactless payment transactions, such as, payments made in accordance with the MasterCard™ PayPass™ protocol or the like. Such protocols may use radio-frequency identification (RFID) or near-field-communications (NFC). According to the dCVC3 process, when a customer transfers their payment information (also known as transaction information) to the merchant when performing a contactless payment, a dynamic code is included in or with the payment information. The code is dynamic in the sense that it is unique to the transaction.

It is known to perform the dCVC3 process using specially designed payment cards. These payment cards have a communications capability and are capable of generating the dynamic code. For example, the payment card may have an RFID capability in order to communicate with an RFID merchant terminal to provide data to the merchant during a contactless payment. Also, the payment card may have a crypto-processor and store a cryptographic key. The payment card may use the crypto-processor to generate the dynamic code using the payment information and the cryptographic key. The dynamic code and the payment information may be provided as data to the merchant. The dynamic code may be used for authentication and the payment information may be used for authorization.

The dynamic nature of this type of authentication provides improved security since it is harder for third-parties to maliciously generate the dynamic code compared to static codes. However, to perform this type of authentication the payment card must store a cryptographic key and have a crypto-processor to generate the dynamic code using the cryptographic key. This means that the cost of the payment card is high compared to other less technologically advanced payment cards.

Also, in order for the merchant to be able to perform contactless payments, the merchant must have a terminal capable of communicating via a contactless payment protocol, such as, the MasterCard™ PayPass™ protocol or the like. As such, the terminal must have an RFID or NFC capability. This means that the cost of the terminal is high compared to other less technologically advanced terminals.

### SUMMARY

A first aspect provides a method for authenticating a transaction, the method comprising: generating a first authentication code based on transaction information and a first cryptographic key, the transaction information relating to the transaction; providing a data carrier having data comprising the first authentication code and the transaction information; presenting the data carrier to a first server to cause the first server to extract the data from the data carrier; generating a second authentication code based on a second cryptographic key and the transaction information from the extracted data; and authenticating the transaction based on a comparison between the first authentication code from the extracted data and the second authentication code. In an embodiment, presenting the data carrier to the first server comprises presenting the data carrier to a data capture element of the first server.

In an embodiment, the first server is associated with a first party to the transaction and the first server generates the first authentication code and provides the data carrier to a second party to the transaction, and the second party presents the data carrier to the first server.

In an embodiment, the data further comprises a transaction amount being an amount received for the transaction by the first party from the second party; and the method further comprises: authorizing the transaction based on a comparison between the transaction amount from the extracted data and a transaction charge associated with the transaction.

In an embodiment, the first authentication code is generated based on the transaction amount and the second authentication code is generated based on the transaction amount from the extracted data.

In an embodiment, the first server performs the steps of generating the second authentication code, authenticating the transaction and/or authorizing the transaction.

In an embodiment, the method further comprises sending the extracted data from the first server to an authentication server, and the authentication server performs the steps of generating the second authentication code, authenticating the transaction and/or authorizing the transaction.

In an embodiment, the first server is associated with a first party to the transaction and the first authentication code is generated by a device associated with a second party to the transaction, and wherein the device provides the data carrier and presents the data carrier to the first server.

In an embodiment, the data further comprises a transaction charge and account information, the transaction charge being a charge associated with the transaction, the account information identifying an account for use in the transaction; and the method further comprises: determining an amount of available credit in the account using the account information from the extracted data; and authorizing the transaction based on a comparison between the determined amount of available credit and the transaction charge from the extracted data.

In an embodiment, the first authentication code is generated based on the transaction charge and the account information, and the second authentication code is generated based on the transaction charge from the extracted data and the account information from the extracted data.

In an embodiment, authorizing the transaction comprises releasing funds from the account, the funds being equal to the transaction charge from the extracted data.

In an embodiment, the method further comprises sending the extracted data from the first server to an issuer server associated with an issuer of the account, and the issuer server performs the steps of generating the second authentication code, authenticating the transaction, determining the amount of available credit and authorizing the transaction.

In an embodiment, the data carrier is a graphical representation of the data, and presenting the data carrier to the first server comprises: presenting the graphical representation to a scanning device of the first server; detecting the presented graphical representation at the scanning device; and extracting the data from the detected graphical representation by the scanning device.

In an embodiment, the graphical representation is a Quick Response (QR) code or a barcode.

In an embodiment, the data carrier is an apparatus with a computer-readable storage medium having stored thereon the data, and presenting the data carrier to the first server comprises: presenting the apparatus to a reading device of the first server to establish communication between the apparatus and the reading device; and extracting the data from the computer-readable storage medium by the reading device.

In an embodiment, the apparatus is a wireless computing device or a payment card having a magnetic stripe and/or a radio-frequency identification (RFID) microchip and antenna.

In an embodiment, the first and second cryptographic keys are identical.

In an embodiment, the transaction is authenticated if the first authentication code from the extracted data corresponds with or matches the second authentication code.

In an embodiment, the transaction information comprises an application transaction counter (ATC) and an unpredictable code (UN) and the first and second authentication codes are dynamic card validation codes (dCVC3).

A second aspect provides a server for authenticating a transaction, the server being associated with a first party to the transaction, the server comprising: at least one processor; and at least one memory including computer program code; the at least one memory and the computer program code configured to, with the at least one processor, cause the server at least to: generate a first authentication code based on transaction information and a first cryptographic key, the transaction information relating to the transaction; provide a data carrier having data comprising the first authentication code and the transaction information to a second party to the transaction; extract the data from the data carrier when the second party presents the data carrier to the server; generate a second authentication code based on a second cryptographic key and the transaction information from the extracted data; and authenticate the transaction based on a comparison between the second authentication code and the first authentication code from the extracted data. In an embodiment, the data carrier is presented to a data capture element of the server.

In an embodiment, the data further comprises a transaction amount being an amount received for the transaction by the first party from the second party; and the at least one memory and the computer program code are configured to, with the at least one processor, further cause the server at least to: authorize the transaction based on a comparison between the transaction amount from the extracted data and a transaction charge associated with the transaction.

In an embodiment, the first authentication code is generated based on the transaction amount and the second authentication code is generated based on the transaction amount from the extracted data.

In an embodiment, the data carrier is an apparatus with a computer-readable storage medium having stored thereon the data and the server further comprises a reader, and the second party presents the apparatus to the reader to present the data carrier to the server, the reader being configured in use to establish communication with the presented apparatus and extract the data from the computer-readable storage medium.

In an embodiment, the apparatus is a wireless computing device, a cellular phone or a payment card having a radio-frequency identification (RFID) microchip and antenna.

In an embodiment, the data carrier is a graphical representation of the data and the server further comprises a scanner, and the second party presents the graphical representation to the scanner to present the data carrier to the server, the scanner being configured in use to detect the presented graphical representation and extract the data therefrom.

In an embodiment, the graphical representation is a Quick Response (QR) code or a barcode.

In an embodiment, the first and second cryptographic keys are identical.

In an embodiment, the transaction is authenticated if the first authentication code from the extracted data corresponds with or matches the second authentication code.

In an embodiment, the transaction information comprises an application transaction counter (ATC) and an unpredictable code (UN) and the first and second authentication codes are dynamic card validation codes (dCVC3).

A third aspect provides a device for use in a system for authenticating a transaction, the device being associated with a second party to the transaction, the device comprising: at least one processor; and at least one memory including computer program code; the at least one memory and the computer program code configured to, with the at least one processor, cause the device at least to: generate a first authentication code based on transaction information and a first cryptographic key, the transaction information relating to the transaction; provide a data carrier having data comprising the first authentication code and the transaction information; present the data carrier to a first server, the first server being associated with a first party to the transaction. In an embodiment, the data carrier is presented to a data capture element of the first server.

A fourth aspect provides a first server for use in a system for authenticating a transaction, the first server being associated with a first party to the transaction, the first server comprising: at least one processor; and at least one memory including computer program code; the at least one memory and the computer program code configured to, with the at least one processor, cause the first server at least to: extract data from a data carrier when a second party to the transaction presents the data carrier to the first server, the data comprising a first authentication code and transaction information, the transaction information relating to the transaction; and send the extracted data to an issuer server. In an embodiment, the data carrier is presented to a data capture element of the first server.

A fifth aspect provides an issuer server for use in a system for authenticating a transaction, the issuer server comprising: at least one processor; and at least one memory including computer program code; the at least one memory and the computer program code configured to, with the at least one processor, cause the issuer server at least to: receive extracted data from a first server, the extracted data comprising a first authentication code and transaction information, the transaction information relating to the transaction; generate a second authentication code based on a second cryptographic key and the transaction information from the extracted data; and authenticate the transaction based on a comparison between the second authentication code and the first authentication code from the extracted data.

A sixth aspect provides a system for authenticating a transaction, the system comprising: a device according to the third aspect; a first server according to the fourth aspect; and an issuer server according to the fifth aspect.

In an embodiment, the data on the data carrier provided by the device, the data on the data carrier presented to the first server and the data received by the issuer server further comprises a transaction charge and account information, the transaction charge being a charge associated with the transaction, the account information identifying an account for use in the transaction; wherein the issuer server is further caused to: determine an amount of available credit in the account using the account information from the extracted data; and authorize the transaction based on a comparison between the determined amount of available credit and the transaction charge from the extracted data.

In an embodiment, the first authentication code is generated based on the transaction charge and the account information, and the second authentication code is generated based on the transaction charge from the extracted data and the account information from the extracted data.

In an embodiment, when the issuer server is caused to authorize the transaction, the issuer server is configured to release funds from the account, the funds being equal to the transaction charge from the extracted data.

In an embodiment, the data carrier is a graphical representation of the data and the first server further comprises a scanner, and the device presents the graphical representation to the scanner to present the data carrier to the first server, the scanner being configured in use to detect the presented graphical representation and extract the data therefrom.

In an embodiment, the graphical representation is a Quick Response (QR) code or a barcode.

In an embodiment, the first and second cryptographic keys are identical.

In an embodiment, the transaction is authenticated if the first authentication code from the extracted data corresponds with or matches the second authentication code.

In an embodiment, the transaction information comprises an application transaction counter (ATC) and an unpredictable code (UN) and the first and second authentication codes are dynamic card validation codes (dCVC3).

A seventh aspect provides a computer-readable storage medium having stored thereon computer program code which when executed by a computer causes the computer to execute a method in accordance with the first aspect.

An eighth aspect provides a computer program comprising software code adapted to perform a method in accordance with the first aspect.

### BRIEF DESCRIPTION OF THE DRAWINGS

Embodiments of the present invention will be better understood and readily apparent to one of ordinary skill in the art from the following written description, by way of example only, and in conjunction with the drawings, wherein like reference signs relate to like components, in which:

FIG. 1 is a block diagram of a system for authenticating a transaction in accordance with an embodiment of the present invention;

FIGS. 2a, 2b and 2c are flow diagrams of a method for authenticating a transaction using the system of FIG. 1, in accordance with an embodiment of the present invention;

FIG. 3 is a block diagram of a server for authenticating a transaction in accordance with an embodiment of the present invention;

FIG. 4 is a flow diagram of a method for authenticating a transaction using the server of FIG. 3, in accordance with an embodiment of the present invention;

FIG. 5 is a flow diagram of a method for authenticating a transaction in accordance with an embodiment of the present invention;

FIG. 6 is a block diagram of an exemplary computer system for use in various embodiments of the present invention; and

FIG. 7 is a block diagram of a wireless computing device for use in various embodiments of the present invention.

### DETAILED DESCRIPTION

Embodiments of the present invention will be described, by way of example only, with reference to the drawings. Like reference numerals and characters in the drawings refer to like elements or equivalents.

Some portions of the description which follow are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “providing”, “determining”, “presenting”, “generating”, “authenticating”, “authorizing”, “detecting”, “receiving”, “sending”, “extracting”, “transmitting”, “comparing”, “establishing” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus (i.e. physical entities) for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program and the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer-readable medium. The computer-readable medium may include storage devices such as magnetic or optical disks, memory chips, or other storage devices suitable for interfacing with a general purpose computer. The computer-readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of a method in accordance with an embodiment.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Various embodiments of the present invention relate to a method for authenticating a transaction and corresponding servers, systems, devices, computer-readable storage mediums and computer programs. In an embodiment, authentication is performed in accordance with of the dynamic Card Validation Code (dCVC3) standard.

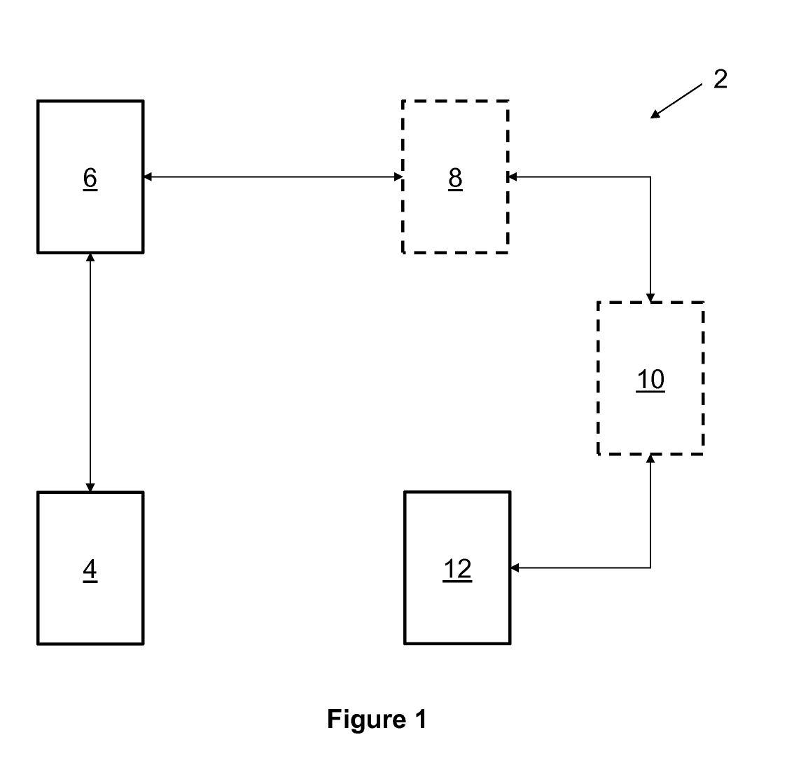

FIG. 1 is a block diagram of a system 2 for authenticating a transaction, in accordance with an embodiment of the present invention. In an embodiment, the system 2 comprises a device 4, a first server 6, an acquirer server 8, an interface server 10 and an issuer server 12. The device 4 is in communication with the first server 6. The first server 6 is also in communication with the acquirer server 8. The acquirer server 8 is also in communication with the interface server 10. The interface server 10 is also in communication with the issuer server 12. It is to be understood that ‘in communication with’ is intended to include both a ‘direct’ communication link between both elements and an ‘indirect’ communication link between both elements, an indirect link being via one or more other elements or networks.

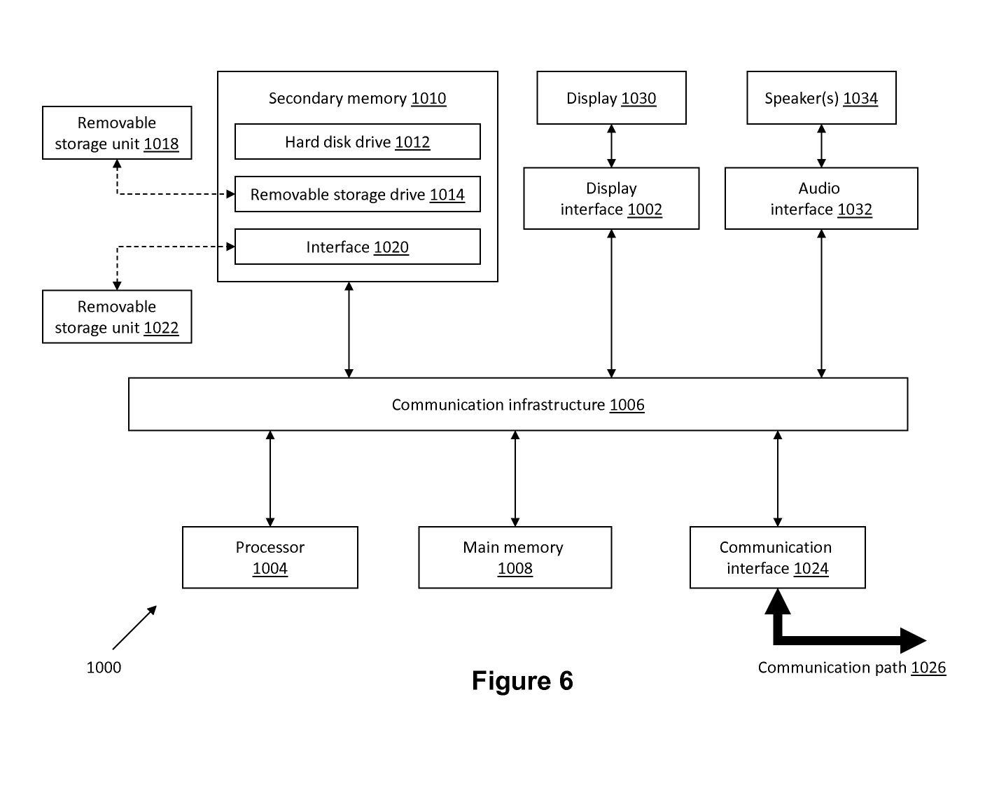

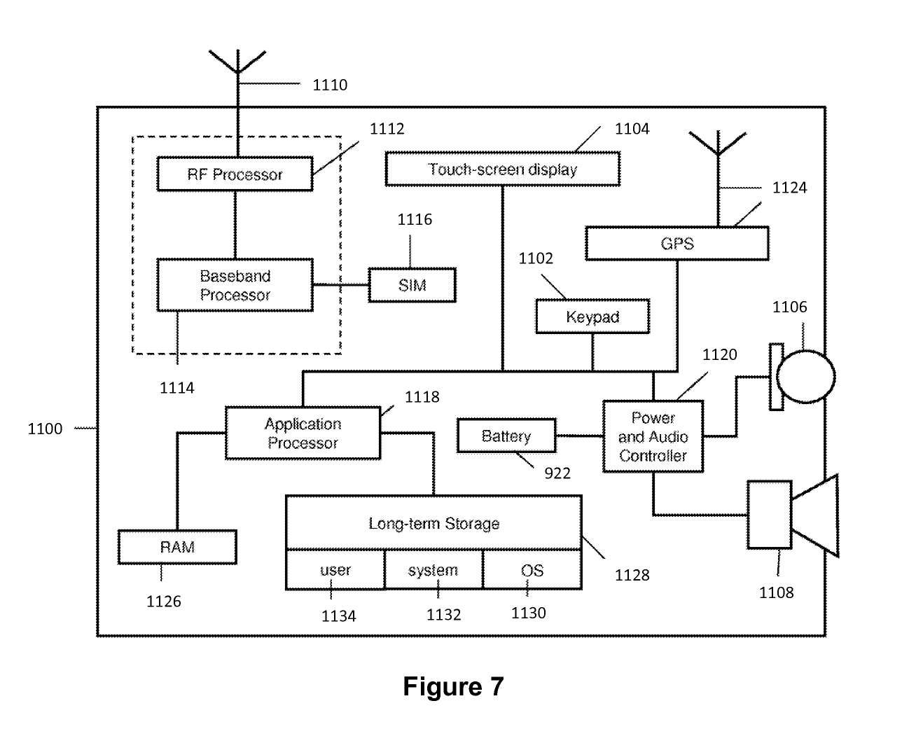

In an embodiment, the device 4, the first server 6, the acquirer server 8, the interface server 10 and/or the issuer server 12 are each a computer system or a plurality of interconnected computer systems. In this way, each server or device may be provided by a single physical apparatus or distributed across a number of different physical apparatuses. An exemplary computer system is described below with reference to FIG. 6. Additionally or alternatively, the device 4 may be a wireless computing device, for example, as described below with reference to FIG. 7.

In an embodiment, the first server 6 may be associated with a first party to the transaction, for example, a merchant. In an embodiment, the device 4 may be associated with a second party to a transaction, for example, a customer. In an embodiment, the transaction between the first and second parties may be the exchange of a good and/or service for a payment (e.g. money). For example, the first server 6 may host a website on which one or more goods and/or services are offered for sale. The second party (e.g. the customer) may use the device 4 to browse the website and select a good or service for purchase from the first party (e.g. the merchant).

In an embodiment, the acquirer server 8 may be associated with a financial institution or company which issues an account of the first party (e.g. the merchant).

For example, the account of the first party may be a bank account and the acquirer server 8 may be associated with the bank which provides the account. On the other hand, the issuer server 12 may be associated with a financial institution of company which issues an account of the second party (e.g. the customer). For example, the account of the second party may be a bank account and the issuer server 12 may be associated with the bank which provides the account.

In an embodiment, the acquirer server 8 may not be configured to communicate directly with the issuer server 12. For example, the acquirer server 8 may not know the address of the issuer server 12 and, therefore, the acquirer server 8 may not know how to send messages to the issuer server 12. Additionally, the issuer server 12 may not know the address of the acquirer server 8 and, therefore, the issuer server 12 may not be able to send messages to the acquirer server 8. However, both the acquirer server 8 and the issuer server 12 may know the address of the interface server 10 and, therefore, the interface server 10 may provide a means by which the acquirer server 8 may communicate with the issuer server 12. In this way, the interface server 10 provides an interface between the acquirer server 8 and the issuer server 12. In an embodiment, the interface server 10 is controlled and operated by a transaction facilitator, such as, MasterCard™.

It is to be understood that in an embodiment, the system 2 may not include the acquirer server 8 and/or the interface server 10. The acquirer server 8 and the interface server 10 are drawn in phantom in FIG. 1 to indicate this. In this way, the first server 6 may communicate directly with the issuer server 12 or via only one of the acquirer server 8 and interface server 10. Where the acquirer server 8 and/or the interface server 10 are present, they operate to forward messages between the first server 6 and the issuer server 12.

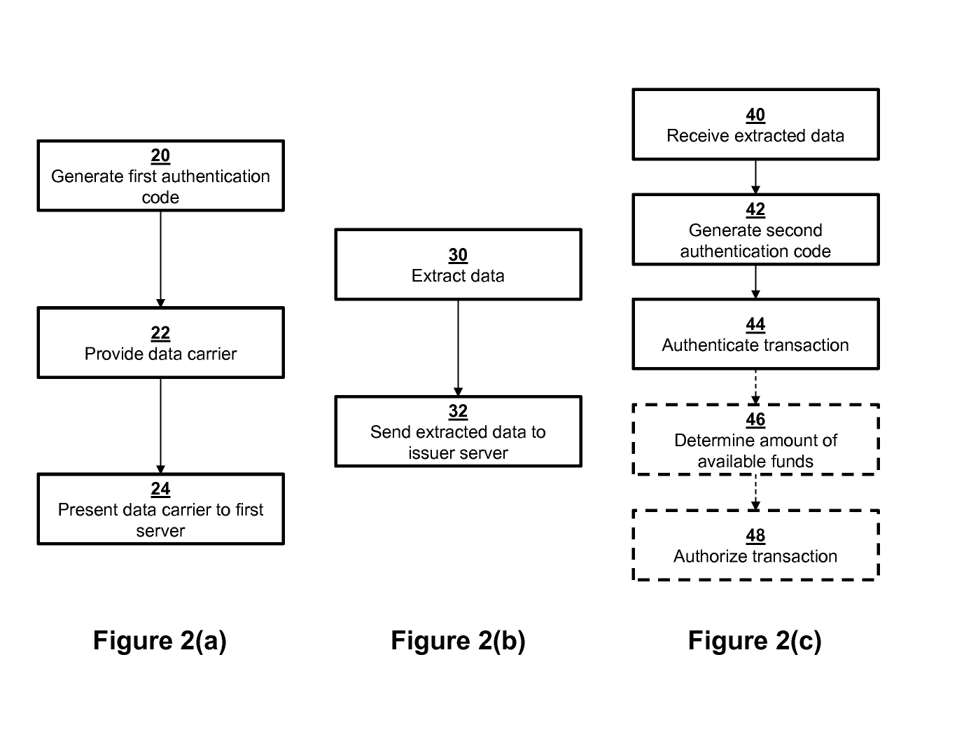

The operation of system 2 in performing a method for authenticating a transaction will now be explained with reference to the flow diagrams of FIGS. 2a, 2b and 2c. In an embodiment, the flow diagram of FIG. 2a is performed by the device 4, the flow diagram of FIG. 2b is performed by the first server 6 and the flow diagram of FIG. 2c is performed by the issuer server 12.

In FIG. 2a, processing begins at block 20, wherein the device 4 generates a first authentication code based on transaction information and a first cryptographic key. The first cryptographic key may be stored on the device 4. The transaction information relates to the transaction to be authenticated. In an embodiment, the transaction information may include a transaction counter which may be incremented by the device 4 for each new transaction initiated using the device 4. In an embodiment, the transaction counter may be an Application Transaction Counter (ATC) as defined with reference to the dynamic Card Validation Code (dCVC3) standard. In this case, the first authentication code may be a dCVC3 code and the transaction information may further comprise an Unpredictable Number (UN) as defined with reference to the dCVC3 standard documentation.

In an embodiment, the transaction information may also include other information relating to the transaction. For example, the transaction information may also include a time and/or date the transaction was initiated, one or more parties to the transaction, and the like.

It is to be understood that the device 4 may receive some or all of the transaction information from another element or device. Additionally or alternatively, the device 4 may generate some or all of the transaction information. For example, when a user of the device 4 initiates a transaction, the device 4 may first generate the transaction information and then generate the first authentication code using the generated transaction information. That is, the ATC and the UN may be generated by the device 4. The user may initiate a transaction when requesting to purchase a product from, for example, a website. The user may be the second party (e.g. the customer). Processing flows to block 22 after the first authentication code has been generated.

At block 22, a data carrier is provided. The data carrier includes data and the data includes the first authentication code and the transaction information. In an embodiment, the data carrier is a graphical representation of the data, for example, a Quick Response (QR) code or a barcode. The data carrier may be provided by the device 4 in that the device 4 may generate the graphical representation (e.g. a QR code) which uniquely represents the first authentication code and the transaction information. Alternatively, the graphical representation may be generated by another element or device and only received and then provided by the device 4. In either case, the device 4 provides the data carrier. Alternatively, the data carrier may be a data packet which is generated or received by the device 4. The data packet may include the first authentication code and the transaction information. It is to be understood that the graphical representation is a representation of the data, whereas the data packet is the raw data itself. Processing flows to block 24 after the data carrier has been provided. It is to be understood that the data carrier may be provided by the device 4, but not provided to anyone in particular. For example, the data carrier may just be displayed on a display screen of the device 4.

At block 24, the data carrier is presented to the first server. In an embodiment, the device 4 presents the data carrier to the first server 6. For example, the device 4 may display the data carrier (e.g. a QR code) on a display screen of the device 4 and a user of the device 4 may position the display screen of the device 4 opposite a scanning device or scanner of the first server 6. The scanning device or scanner represents a data capture element of (or linked to) the first server 6 and so the data carrier may be presented to the data capture element of the first server 6. For example, the scanner may be a QR code scanner. In this way, the data carrier may be detected and read by the first server 6. In another embodiment, the device 4 may transmit the data carrier to the first server 6 via a wired and/or wireless communication path. For example, the device 4 and the first server 6 may be capable of communicating with each other via GSM, GPRS, CDMA, WiFi or Bluetooth™ and the device 4 may transmit the data carrier to the first server 6, or the first server 6 may fetch the data carrier from the device 4. The data carrier may be transmitted as either a graphical representation or a data packet. In any case, the data carrier is presented (e.g. displayed or sent) to the first server 6.

In FIG. 2b, processing begins at block 30. At block 30, the first server 6 extracts the data from the data carrier presented to the first server 6 by the device 4. For example, in the case where a QR code is displayed on a display screen of the device 4 and shown to a scanner of the first server 6, the scanner detects the QR code and extracts the data from the QR code. Where the data carrier is received via wireless/wired communication, the first server 6 extracts the data once the data carrier is received from the device 4. In this case, the data carrier transmitted may be a graphical representation or a data packet. Processing flows to block 32 after the data has been extracted.

At step 32, the first server 6 sends the extracted data to the issuer server 12. In an embodiment, the extracted data is sent directly to the issuer server 12. However, in another embodiment, the extracted data is sent to the issuer server 12 via the acquirer server 8 and/or the interface server 10. In any case, the extracted data is sent to the issuer server 12.

In FIG. 2c, processing begins at block 40. At block 40, the issuer server 12 receives the extracted data from the first server 6. This is a corresponding receiving operation to the sending operation of block 32 of FIG. 2b. Processing flows to block 42 after the extracted data is received.

At block 42, the issuer server 12 generates a second authentication code. The extracted data received in block 40 comprises both the above-mentioned first authentication code and transaction information. The second authentication code is generated based on the transaction information from the extracted data and a second cryptographic key. The second cryptographic key may be stored on the issuer server 12. The second cryptographic key may be identical to the first cryptographic key used above by the device 4 in block 20. As mentioned above, the extracted transaction information may include a transaction counter which may be incremented for each new transaction initiated by the device 4. In an embodiment, the transaction counter may be an Application Transaction Counter (ATC) as defined with reference to the dynamic Card Validation Codes (dCVC3) standard. In this case, the second authentication code may be a dCVC3 code and the extracted transaction information may further comprise an Unpredictable Number (UN), as defined with reference to the dCVC3 standard documentation. Processing flows to block 44 after the second authentication code is generated.

At block 44, the issuer server 12 authenticates the transaction initiated by the device 4 based on a comparison between the first authentication code from the extracted data received in block 40 and the second authentication code generated in block 42. In an embodiment, the transaction is authenticated if the two authentication codes match, i.e. are identical. In another embodiment, the transaction may be authenticated if the two codes substantially match or correspond. For example, extracting the data at the first server 6 (block 30) or sending the extracted data from the first server 6 to the issuer server 12 (blocks 32 and 40) may result in some degradation of the data, for example, as a result of noise or losses due to the transmission medium. Accordingly, some slight differences between the two codes may be acceptable. For example, if the two codes are 70%, 80%, 90%, 95% or 99% the same, the transaction may be authenticated. Of course, if the two codes do not match or sufficiently correspond, the transaction may not be authenticated.

In an embodiment, no further operations may be performed since the transaction has been either authenticated or not authenticated based on the comparison in block 44. However, in some embodiments, if the transaction is authenticated, a further authorization process is performed. The following describes this optional authorization process in more detail. The optional nature is indicated in FIG. 2 by blocks drawn in phantom.

In an embodiment, in order to implement the authorization process, the operation in block 22 is modified. Specifically, the data on the data carrier comprises the first authentication code and the transaction information as before, but now also includes a transaction charge and account information. In the embodiment, the transaction charge is a charge that is associated with the transaction. For example, in the above example of the second party (e.g. the customer) buying a good and/or service from the first party (e.g. the merchant), the transaction charge may be the cost or price of the good and/or service. In an embodiment, the account information identifies an account for use in the transaction. For example, the account information may identify an account (e.g. a bank account) of the second party (e.g. the customer) which the second party intends to use to provide payment to the first party (e.g. the merchant) for the good and/or service. In an embodiment, the account information may include: a payment card number, a Primary Account Number (PAN), a payment card expiry date, a dynamic Card Verification Code (CVC3). In an embodiment, the account information may be provided as ‘Track Data’ as defined in the dCVC3 standard documentation.

It is to be understood that the additional data, i.e. the transaction charge and the account information, is included in the data carrier provided in block 22 and presented in block 24. Therefore, the additional data is extracted in block 30, sent in block 32 and received in block 40. Accordingly, at block 46, the issuer server 12 determines the account identified in the account information which was received in block 40.

As mentioned above, the issuer server 12 may be associated with a financial institution or company which issues an account of the second party (e.g. the customer). In an embodiment, the issuer server 12 is associated with the issuer of the account identified in the account information from the extracted data received at block 40. For example, the interface server 10 may have sent the extracted data to the issuer server 12 because the interface server 10 knows that the issuer server 12 is the issuer of the account identified in the account information. The interface server 10 may ‘know’ based on the account information.

The issuer server 12 may identify the account based on the account information and determine an amount of available funds (e.g. money) in the account. For example, the issuer server 12 may comprise or be in communication with a database which contains an entry for each account issued by the issuer. The issuer server 12 may identify the entry in the database relating to the account using the account information (e.g. the account number). In this way, the issuer server 12 may be capable of determining the amount of available funds in the account identified by the account information from the extracted data. Processing flows to block 48 after the amount of available funds has been identified.

At block 48, the issuer server 12 authorizes the transaction based on a comparison between the amount of available funds determined in block 46 and the transaction charge from the extracted data. In an embodiment, the transaction may be authorized if the amount of available funds is greater than or equal to the transaction charge. If the transaction charge is greater than the amount of available funds, the transaction may not be authorized. However, if the account holder of the account has or is eligible for an overdraft, the transaction may still be authorized if the overdraft meets the difference between the amount of available funds and the transaction charge.

In an embodiment, if the transaction is authorized, the issuer server 12 releases funds from the account which are equal to the transaction charge. In other words, the issuer server 12 may deduct from the account an amount of money equal to the transaction charge. Additionally, the issuer server 12 may send a message to the acquirer server 8 authorizing the acquirer to show that a payment equal to the transaction charge has been made into an account of the first party (e.g. the merchant). This account may be identified by the first server 6 and/or the acquirer server 8 in block 32 when the first server 6 sends the extracted data to the issuer server 12 via the acquirer server 8 and interface server 10. In this way, the first party (e.g. the merchant) may receive payment for the good and/or service purchased by the second party (e.g. the customer). It is to be understood that the issuer server 12 may communicate with the acquirer server via the interface server 10. Also, the acquirer server 8 may send a message to the first server 6 to inform the first party (e.g. the merchant) that they have received payment from the second party (e.g. the customer). Accordingly, the first party can then provide the purchased good and/or service to the second party. The first server 6 may also send a message to the device 4 to inform the second party that the transaction has been successful.

It is to be understood that the authentication process of block 44 is performed to identify whether or not the party initiating the transaction is entitled to perform the transaction. The party is only entitled to perform the transaction is they are able to generate the first authentication code. For example, the transaction is authenticated if the authentication code generated by the second party (e.g. the customer) matches or corresponds with the code generated by the issuer server. If the second party initiates a transaction and specifies an account from which payment is to be made, but the code provided by the second party does not match the issuer's code, the transaction is not authenticated and no financial transaction is entertained. In summary, therefore, the authentication process determines whether or not the person requesting the transaction is allowed to do so. In this phase, there are no financial considerations. Only if the authentication process is successful are the financial aspects considered.

It is to be understood that the authorization process of block 48 is performed to identify whether or not the party initiating the transaction has enough money to pay for the good and/or service to be purchased. Authorization may only be performed once authentication is successful. The transaction is only authenticated if sufficient funds are available in the account specified by the person initiating the transaction. If there are insufficient funds, the transaction may not be authorized, i.e. payment may not be made. If there are sufficient funds, the transaction may be authorized, i.e. payment may be made.

In a modification to the above-described embodiment, security may be enhanced. Specifically, the first authentication code may be generated not only based on the transaction information and the first cryptographic key, but also based on the transaction charge and the account information. Since more data is used to generate the first authentication code, the authentication process is more secure, i.e. the first authentication code is more difficult for third-parties to maliciously generate. In this case, the second authentication code is generated not only based on the second cryptographic key and the transaction information from the extracted data, but also based on the transaction charge and the account information from the extracted data.

Accordingly to the above-described embodiments, the second party (e.g. the customer) associated with the device 4 may initiate a transaction which is then authenticated and authorized. These processes may be performed using dCVC3 codes which provide added security owing to their dynamic nature. Conventionally, dCVC3 codes may only be used in contactless payments, i.e. payments made using the MasterCard™ PayPass™ protocol or the like. This conventional process requires the use of expensive payment cards having a crypto-processor and being capable of generating dynamic codes. However, according to at least some of the above-described embodiments, dCVC3 may be used in non-contactless payments/transactions. In particular, a graphical representation (e.g. a QR code) may be used as a medium for transferring data. Alternatively, the data may be transferred simply as a data packet. Instead of using an expensive payment card, an existing device (e.g. a wireless computing device such as a cellular phone) may be used to store the cryptographic key and generate the dynamic code. Additionally, the data carrier does not need to have an RFID or NFC capability. Also, instead of using an expensive terminal capable of communicating via a contactless payment protocol (e.g. using RFID or NFC), it is possible to use a server capable of reading a graphical representation or receiving a data packet via any wired/wireless communication protocol. In this way, it is possible to obtain the security benefits of dCVC3 without requiring expensive payment cards or expensive contactless payment terminals.

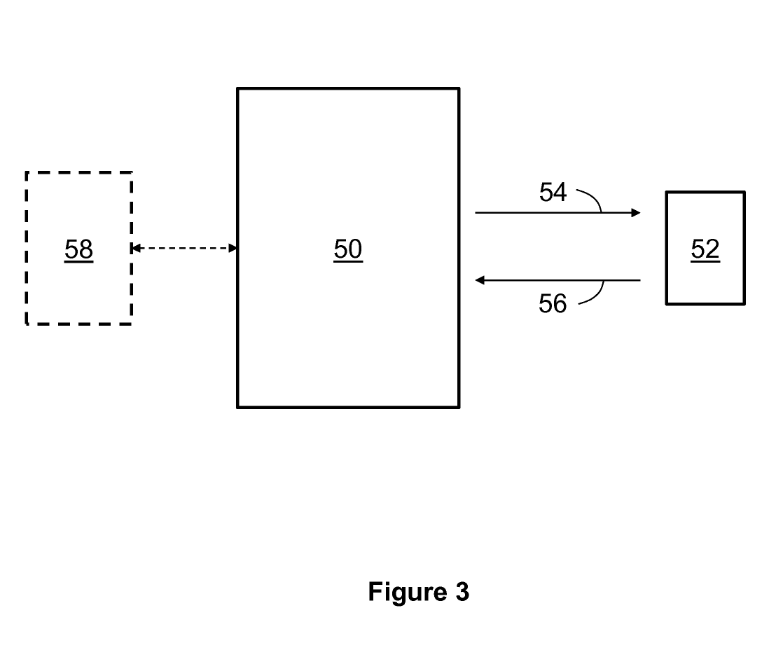

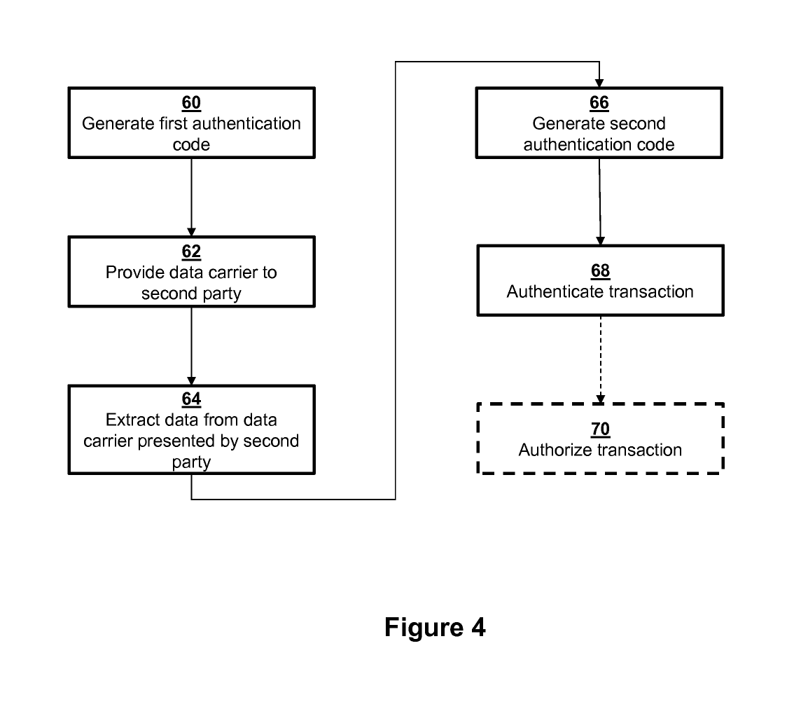

The following describes another embodiment of the present invention with reference to the block diagram of FIG. 3 and the flow diagram of FIG. 4.

FIG. 3 illustrates a server 50 for authenticating a transaction, in accordance with an embodiment. The server 50 is associated with a first party (e.g. a merchant) to the transaction and may be configured in use to provide a data carrier 52 to a second party (e.g. a customer) to the transaction, as indicated by the arrow 54. Additionally, the second party (e.g. the customer) may be configured to provide the data carrier 52 back to the server 50, as indicated by arrow 56. The transaction may involve the provision of a good and/or service from the first party (e.g. the merchant) to the second party (e.g. the customer) in exchange for the provision of money from the second party to the first party. In an embodiment, the data carrier 52 may be provided to the second party by the first server (i.e. arrow 54) when the second party provides payment to the first party. Additionally, the data carrier 52 may be provided to the first server by the second party (i.e. arrow 56) when the second party wants to use or receive the purchased good and/or service. This operation will be described in more detail below with reference to FIG. 4.

In some embodiments, the server 50 is in communication with an authentication server 58, indicated in phantom since it is an optional feature. When the authentication server 58 is present, the authentication server 58 may be configured to perform some or all of the transaction authentication. When the authentication server 58 is not present, the server 58 may be configured to perform the complete transaction authentication.

In an embodiment, the server 50 and the authentication server 58 are each a computer system or a plurality of interconnected computer systems. In this way, each server may be provided by a single physical entity or distributed across a number of different physical entities. An exemplary computer system is described below with reference to FIG. 6.

In an embodiment, the operation of the server 50 is illustrated by the flow diagram of FIG. 4, wherein processing begins at block 60. At block 60, the server 50 generates a first authentication code based on transaction information and a first cryptographic key. This block is analogous to block 20 of FIG. 2a except that the operation is performed by the server 50 of FIG. 3, rather than the device 4 of FIG. 1. Additionally, the server 50 may initiate block 50 based on receiving a purchase request or a payment from the second party (e.g. the customer).

In an embodiment, the first party (e.g. the merchant) is a transit company or organization, such as, for example, a company who runs or controls a transit system (e.g. a train network or a subway system). The second party (e.g. the customer) is a passenger who wishes to travel on the transit system. In this case, the server 50 may provide or be in communication with a computer system which (i) provides passengers with tickets for travel on the transit system, and (ii) permits passengers to use the transit system if they present a valid ticket. For example, the server 50 may include a ticket issuing device for performing operation (i) and a ticket validating device for performing operation (ii). The ticket issuing device may be configured in use to receive payment (i.e. money) from a passenger and issue a ticket to the passenger based on the received payment. The ticket validating device may be configured in use to receive a ticket from the passenger and open a gate or barrier if the ticket is valid so that the passenger can enter and use the transit system. In an embodiment, each of the ticket issuing device and the ticket validating device may be a computer system as described below with reference to FIG. 6 and, as such, the server 50 may be a plurality of interconnected computer systems. It is to be understood that the ticket issuing device would comprise additional hardware to receive payment (e.g. money) and issue tickets, as would be known to a person skilled in the art. Also, the ticket validating device would comprise additional hardware to receive tickets and open gates, as would be known to a person skilled in the art.

Considering the transit system example, in block 60, the server 50 (e.g. the ticket issuing device) may generate the first authentication code in response to receiving a ticket request and/or a ticket payment from the passenger. Processing flows to block 62 after the first authentication code is generated.

At block 62, the server 50 provides a data carrier 52 to the second party (e.g. the passenger). This operation is indicated on FIG. 3 by arrow 54. The data carrier 52 includes data and the data includes the first authentication code and the transaction information from block 60. In an embodiment, the data carrier 52 may be a graphical representation of the data, such as, for example, a QR code or a barcode. In another embodiment, the data carrier 52 may be an apparatus with a computer-readable storage medium having stored thereon the data. The computer-readable storage medium may store the data as a graphical representation or simply as the data itself (i.e. a data packet). In an embodiment, the apparatus comprises an RFID or NFC microchip and antenna, and/or a magnetic stripe. For example, the apparatus may be a payment card, such as, a payment card configured in use to make contactless payments in accordance with the MasterCard™ PayPass™ protocol or the like. Additionally, the apparatus may be a computing device, such as, a cellular phone or tablet computer. The computing device may also be configured in use to make contactless payments in accordance with the MasterCard™ PayPass™ protocol or the like.

It is to be understood that the server 50 may provide the data carrier 52 in the sense that the server 50 may form the data carrier and give it to the second party (e.g. the passenger). For example, where the data carrier is a graphical representation, the data carrier may be generated by the server 50 and then printed onto a paper sheet (e.g. a ticket stub). The printed graphical representation may be physically given to the second party, for example, by the ticket issuing device. On the other hand, the data carrier may be an apparatus (e.g. a payment card) with a computer-readable storage medium having stored thereon the data. In this case, the apparatus may be given to the second party (e.g. the passenger) by the server 50. For example, the server 50 may take a new or recycled payment card held in the ticket issuing device, configure the card by loading the data onto the card, and then give the card to the second party (e.g. the passenger). The data may be loaded via wired or wireless transmission. The data may include a graphical representation (e.g. a QR code) of the data or simply a data packet (e.g. raw data) of the data.

It is to be understood that the server 50 may provide the data carrier 52 in the sense that it may configure the data carrier 52 to include the data. For example, where the data carrier 52 is an apparatus with a computer-readable storage medium having stored thereon the data, the data carrier 52 may be configured by loading the data onto the computer-readable storage medium. In this case, the apparatus may already be owned by the second party (e.g. the passenger) and presented to the server 50 by the second party. For example, the second party may present their cellular phone or existing payment card to the server 50 so that it can be configured by the server 50. In this way, the server 50 configures the apparatus to provide the data carrier to the second party (e.g. the passenger).

In summary, therefore, providing the data carrier can include: (i) giving the second party a printed graphical representation of the data; (ii) giving the second party an apparatus with the data/graphical representation stored thereon; or, (iii) loading the data/graphical representation onto an apparatus owned by the second party.

In any case, once the data carrier 52 has been provided to the second party (e.g. the passenger) the second party has received the ticket that they have purchased. This ticket can then be used at a later time in exchange for travel on the transit system. Processing flows to block 64 after the second party presents the data carrier 52 to the server 50. This operation is indicated on FIG. 3 by the arrow 56.

At block 64, the server 50 extracts the data from the data carrier 52 when the second party (e.g. the passenger) presents the data carrier 52 to the server 50. For example, where the data carrier is a graphical representation, the second party may position the graphical representation in front of a scanning device or scanner of the server 50. The scanning device or scanner represents a data capture element of (or linked to) the server 50 and so the data carrier 52 may be presented to the data capture element of the server 50. For example, the scanner may form part of the ticket validating device. The scanner may be configured in use to detect the graphical representation and extract the data therefrom, as would be known to the person skilled in the art. The presented graphical representation may be printed on a sheet of paper or may be displayed on a screen of an apparatus, as described above.

Alternatively, where the data carrier 52 is an apparatus, the second party may bring the apparatus into close proximity (e.g. less than 10 cm) with a reading device or reader of the server 50. The reading device or reader represents a data capture element of (or linked to) the server 50 and, as before, the data carrier 52 may be presented to the data capture element of the server 50. For example, the reader may form part of the ticket validating device. The reader and the apparatus may be configured to perform contactless payments in accordance with the MasterCard™ PayPass™ protocol or the like. Stated differently, the reader and the apparatus may be capable of communicating with each other via RFID or NFC. In this way, the reader may be configured to establish communication with the apparatus and extract the data from its computer-readable storage medium. In this way, the reader may be a contactless payment terminal, such as, a MasterCard™ PayPass™ terminal or the like. Alternatively, the reader may be configured to establish communication with the apparatus via some other wired or wireless protocol in order to extract the data. The data may include a graphical representation (e.g. a QR code) of the data or simply a data packet (e.g. raw data) of the data.

Once the data has been extracted from the data carrier 52 by the server 50, processing flows to block 66. At block 66, the server 50 generates a second authentication code based on a second cryptographic key and the transaction information from the data extracted in block 64. This operation is analogous to the operation of block 42 of FIG. 2c, except that it is performed by the server 50 of FIG. 3 rather than the issuer server 12 of FIG. 1. In an embodiment, the second cryptographic key is stored on the server 50. In an embodiment, the second cryptographic key is the first cryptographic key, or is identical to the first cryptographic key. Processing flows to block 68 after the second authentication code has been generated.

At block 68, the server 50 authenticates the transaction based on a comparison between the second authentication code and the first authentication code from the extracted data. This operation is analogous to block 44 of FIG. 2c, except that it is performed by the server 50 of FIG. 3 rather than the issuer server 12 of FIG. 1. The result of block 68 is either than the transaction is authenticated or that the transaction is not authenticated. If the transaction is authenticated, the server 50 (e.g. the ticket validating device) may permit the passenger to enter and use the transit system, for example, by opening a gate. On the other hand, if the transaction is not authenticated, the server 50 (e.g. the ticket validating device) may prevent the passenger from entering and using the transit system, for example, by closing the gate.

The above-described embodiment may be suitable for use in a transit system in which all journeys cost the same amount of money. For example, the server 50 does not consider how much the passenger paid, just that the passenger made a payment. The following describes a modification to the above-described embodiment in which once authentication (block 68) is successful a further optional authorization process (block 70) is performed. The following describes this further authorization process in more detail.

In an embodiment, in order to implement the authorization process, the operation in block 62 is modified. Specifically, the data on the data carrier 52 comprises the first authentication code and the transaction information as before, but now also a transaction amount. In an embodiment, the transaction amount is an amount received for the transaction by the first party (e.g. the transit company) from the second party (e.g. the passenger). It is to be understood that the transaction amount is included in the data carrier 52 provided in block 62 and presented/extracted in block 64.

At block 70, the server 50 authorizes the transaction based on a comparison between the transaction amount from the extracted data and a transaction charge associated with the transaction. In an embodiment, the transaction charge is the cost of the good and/or service requested by the second party, for example, the cost of the journey requested by the passenger. The transaction charge may be manually or automatically designated when the passenger presents the data carrier 52 to the server 50. Considering the transit example, the passenger may select the journey they wish to take when presenting the data carrier 52 to the server 50. Additionally or alternatively, the specific ticket validating device of the server 50 to which the data carrier 52 is presented may automatically identify the journey and thereby designate the transaction charge. For example, the ticket validating device may be positioned at a barrier which controls access to a train which travels to a particular destination or via a particular route. A ticket to travel to this destination or via this route may cost a certain amount, i.e. the transaction charge. Therefore, presenting the data carrier 52 to this particular ticket validation device of the server 50 may automatically designate this transaction charge.

In an embodiment, the transaction may be authorized if the transaction amount is greater than or equal to the transaction charge. That is, the transaction may be authorized if the amount paid by the passenger is at least as much as the price of the journey the passenger wishes to take. On the other hand, if the transaction amount is less than the transaction charge, the transaction may not be authorized. Whether or not the second party (e.g. the passenger) receives the good and/or service from the first party (e.g. the transit company) may be conditional not only on successful authentication, but also on successful authorization. In this way, the above-described embodiment is suitable for use in a system in which different products cost different amounts, e.g. a transit system in which different journeys cost different amounts.

In a further modification to the above-described embodiment, security may be enhanced. Specifically, the first authentication code may be generated based not only on the transaction information and the first cryptographic key as before, but now also based on the transaction amount. Since more data is used to generate the first authentication code, the authentication process is more secure since the code is more difficult for malicious third-parties to replicate. In this case, the second authentication code is generated based not only on the second cryptographic key and the transaction information from the extracted data as before, but now also based on the transaction amount from the extracted data.

In another modification to the above-described embodiment, the operations of blocks 66, 68 and/or 70 could be performed by the authentication server 58, rather than the server 50. In this way, the first party may out-source the authentication and/or authorization processes to a third-party. In an embodiment, the authentication server 58 is part of a computer system controlled by MasterCard™′ Alternatively, the operations of blocks 66, 68 and 70 may still be performed by the server 50; however, the server 50 may not store the second cryptographic key and, instead, may obtain the second cryptographic key from the authentication server. This may provide additional security to the authentication process.

An advantage of the above-described embodiment is that the process of authentication may be used to control access to a product, for example, a journey on a transit system. In a particular embodiment, authentication via the dCVC3 process can be used to control access to a transit system. A further advantage of some embodiments is that an authorization process may be added to configure the system where different products cost different amounts, for example, where different journeys on the transit system cost different amounts. In this way, a graphical representation of a dCVC3 code or an apparatus carrying a dCVC3 code can be used as a one-time ticket for travel on the transit system. In both cases, the data carrier can be a low cost element since it only has to hold data and does not have to generate it. For example, the data carrier could be: a graphical representation (e.g. a QR code) printed onto a piece of paper; a payment card which only stores a graphical representation or a data packet; or, an existing apparatus which stores the graphical representation or a data packet. The cheap payment card or existing apparatus could provide the data to the server 50 using either contactless payment functionality (e.g. RFID or NFC) or any other type of wired/wireless communication functionality (e.g. Wifi, GSM, GPRS, Bluetooth™).

It is to be understood that, in the above-described embodiments the transit system application was presented merely as a non-limiting example. Some other embodiments could relate to a non-transit application. For example, the first party could be a ‘merchant’ rather than a ‘transit company’, the second party could be a ‘customer’ rather than a ‘passenger’ and the data carrier could be ‘coupon’ or ‘voucher’ rather than a ‘transit ticket’. In an embodiment, the coupon or voucher could be for a particular good and/or service offered by the merchant. For example, the good and/or service could be a tangible product, such as, food, drink, a table, a computer, a bicycle, etc. Also, the good and/or service could be an intangible product, such as, insurance, talk-time over a cellular network, a massage, etc.

It is to be understood that since the server 50 is used to generate the first and second authentication codes, an expensive payment card having a crypto-processor is not required by the second party to perform the transaction. For example, a cheap paper stub having printed thereon a QR code could be used by the customer to perform the transaction. Alternatively, an existing device of the customer may be used. In this way, it is possible to achieve the additional security provided by dCVC3, but without having to use payment cards having crypto-processors.

It is also to be understood that since the first server can either read the data on the data carrier using a scanner (e.g. a QR code scanner) or receive the data via conventional wired/wireless communication (e.g. WiFi), it is not necessary for the first server to be able to communicate via a contactless payment protocol, such as the MasterCard™ PayPass™ protocol or the like. In this way, it is possible to achieve the additional security provided by dCVC3, but without having to use terminals capable of communicating via a contactless payment protocol.

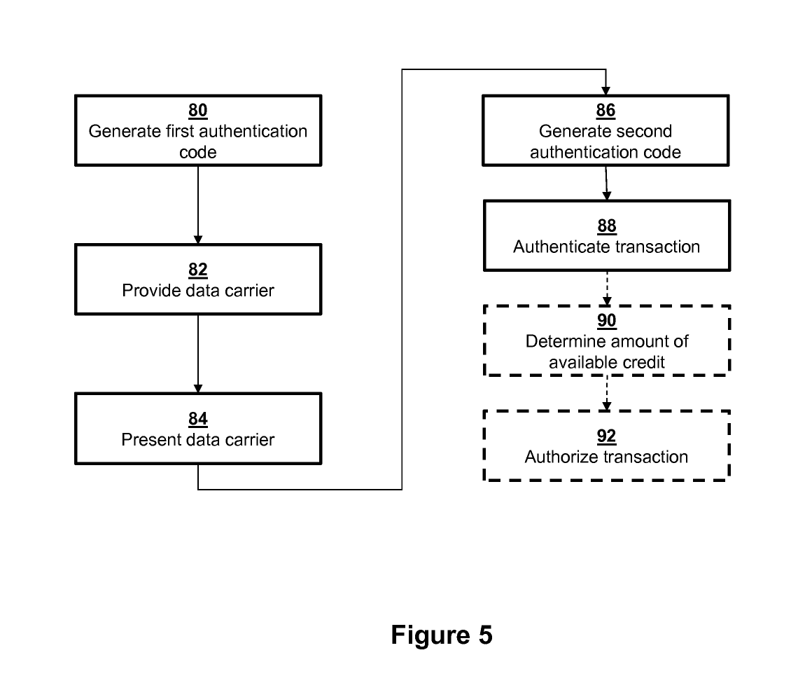

The following describes another embodiment of the present invention with reference to the flow diagram of FIG. 5.

FIG. 5 provides a flow diagram of a method for authenticating a transaction, in accordance with an embodiment. In FIG. 5, processing begins at block 80.

At block 80, a first authentication code is generated based on transaction information and a first cryptographic key. The transaction information relates to the transaction. The transaction information may be as mentioned above in respect of block 20 of FIG. 2a. For example, the transaction information may include a transaction counter indicating a number of the transaction. In an embodiment, the method includes a further step of generating the transaction information, for example, incrementing the transaction counter. Processing flows to block 82 after the first authentication code is generated.

At block 82, a data carrier is provided. The data carrier has data which includes both the first authentication code and the transaction information. In an embodiment, the data carrier is a graphical representation of the data, for example, a QR code or a barcode. In this case, providing the data carrier may include forming or generating the graphical representation. In another embodiment, the data carrier is an apparatus with a computer-readable storage medium having stored thereon the data. In this case, providing the data carrier may include configuring the apparatus by loading the data onto the computer-readable storage medium. The data loaded may include the graphical representation of the data or a data packet of the data.

In an embodiment, the same physical entity (e.g. server or device) performs the operations of blocks 80 and 82. For example, a person initiating the transaction (e.g. a second party or customer) is associated with a device and uses the device to generate the first authentication code and to provide the data carrier (e.g. display the data carrier). In another example, the second party (e.g. the customer) may initiate the transaction with the first party (e.g. the merchant). The first party (e.g. the merchant) may be associated with a server and may use the server to generate the first authentication code and to provide the data carrier to the second party (e.g. the customer) in response the actions of the second party. In any case, the data carrier is provided. Processing flows to block 84 after the data carrier has been provided.

At block 84, the data carrier is presented to a first server to cause the first server to extract the data from the data carrier. In an embodiment, the data carrier is presented to a data capture element of the first server. In any case, the first server is configured in use such that the act of presenting the data carrier to the first server causes the first server to extract the data from the data carrier. For example, where the data carrier is a graphical representation, the first server may further include a scanner (e.g. a QR code scanner) which is configured to detect the presented graphical representation and extract the data therefrom. On the other hand, where the data carrier is an apparatus with an RFID or NFC capability, the first server may further include an RFID or NFC terminal (e.g. a MasterCard™ PayPass™ terminal) which is configured to establish communication with the presented apparatus and extract the data from its computer-readable storage medium. Accordingly, ‘presenting’ may include displaying the data carrier to the first server and/or bringing the data carrier into close proximity (e.g. less than 10 cm) with the first server.

In an embodiment, where the second party (e.g. the customer) initiates the transaction and provides the data carrier, the second party (e.g. the customer) may present that data carrier to the first server which is associated with the first party (e.g. the merchant). On the other hand, where the first party (e.g. the merchant) provides the data carrier to the second party (e.g. the customer) in response to the second party (e.g. the customer) initiating the transaction, the second party (e.g. the customer) may present that data carrier back to the first server of the first party (e.g. the merchant). In any case, processing flows to block 86 after the data carrier has been presented to the first server.

At block 86, a second authentication code is generated based on a second cryptographic key and the transaction information from the data extracted in block 84. This operation is analogous to that of block 42 of FIG. 2c. In an embodiment, the second cryptographic key is the same as the first cryptographic key. Processing flows to block 88 after the second authentication code has been generated.

At block 88, the transaction is authenticated based on a comparison between the first authentication code from the extracted data obtained in block 84 and the second authentication code generated in block 86. This operation is analogous to that of block 44 of FIG. 2c. In an embodiment, the transaction may only be authenticated if the two codes are identical or correspond with each other, as described above with respect to block 44 of FIG. 2c.

In an embodiment, the method of authentication may end here. However, in a first modification, the method may be optionally modified to perform the operations of blocks 90 and 92 (shown in phantom). In a second modification, the method may be modified to perform the operation of only block 92 (i.e. not block 90).

According to the first modification, the data of the data carrier is modified to include a transaction charge and account information. In an embodiment, the transaction charge is a charge associated with the transaction. For example, the transaction may involve the provision of a product from the first party (e.g. the merchant) to the second party (e.g. the customer) in exchange for a payment made by the second party (e.g. the customer) to the first party (e.g. the merchant). In this case, the transaction charge may be the price of the product. In an embodiment, the account information may identify an account (e.g. a bank account) for use in the transaction. In the above example, the account information may be provided by the second party (e.g. the customer) and may specify a bank account from which the payment is to be made.

In view of the above, the transaction charge and the account information are included in the data in block 82, and are part of the data extracted in block 84. At block 90, the account information from the extracted data is used to determine an amount of available credit in the account identified in the account information. For example, an issuer of the account may look-up in a database details of the account to determine the amount of available credit in the account. Processing flows to block 92 after the amount of available credit has been determined.

At block 92, the transaction may be authorized based on a comparison between the amount of available credit determined in block 90 and the transaction charge from the data extracted in block 84. In an embodiment, the transaction is only authorized if the amount of available credit is equal to or greater than the transaction charge. Otherwise, the transaction may be rejected.

According to the second modification, the data of the data carrier is modified to include a transaction amount. For example, the transaction may involve the provision of a product from the first party (e.g. the merchant) to the second party (e.g. the customer) in exchange for a payment made by the second party (e.g. the customer) to the first party (e.g. the merchant). In this case, the transaction amount may be the payment made by the by the second party to the first party.

In view of the above, the transaction amount is included into the data in block 82, and is part of the data extracted in block 84. In the second modification, block 90 is bypassed. At block 92, the transaction is authorized based on a comparison between the transaction amount from the data extracted in block 84 and a transaction charge associated with the transaction. As mentioned above, the transaction charge may be the price of the product. This price may be manually or automatically provided when the data carrier is presented at block 84. In an embodiment, the transaction is only authorized if the transaction amount (i.e. the payment) is greater than or equal to the transaction charge (i.e. the product price). In an embodiment, authorizing the transaction comprises releasing funds from the account, the funds being equal to the transaction charge from the extracted data.

In yet a further modification, security can be improved. For example, considering the first modification, security can be improved if the first and second authentication codes are generated based on the transaction charge and the account information. Considering the second modification, security can be improved if the first and second authentication codes are generated based on the transaction amount. In both cases, security is improved since the authentication codes are generated based on more data and, therefore, it is more difficult for third-parties to maliciously generate the authentication codes.

As mentioned above, in an embodiment, blocks 80 and 82 are performed by a device associated with the second party (e.g. the customer). In this case, the data carrier is provided by the device and the second party presents the data carrier to a server (e.g. the first server) associated with the first party (e.g. the merchant). In this case, the first server may perform the operations of blocks 86 and 88, and the additional operations of the first modification (i.e. blocks 90 and 92). Alternatively, the first server may be in communication with an issuer server and may forward the extracted data to the issuer server. In this case, the issuer server may perform the operations of blocks 86 and 88, and the additional operations of the first modification (i.e. blocks 90 and 92).

As mentioned above, in an embodiment, blocks 80 and 82 are performed by a server (e.g. a first server) associated with the first party (e.g. the merchant). In this case, the data carrier is provided by the first server to the second party (e.g. the customer) and the second party (e.g. the customer) presents the data carrier back to the first server. In this case, the first server may perform the operations of blocks 86 and 88, and the additional operations of the second modification (i.e. block 92). Alternatively, the first server may be in communication with an authentication server and may forward the extracted data to the authentication server. In this case, the authentication server may perform the operations of blocks 86 and 88, and the additional operations of the second modification (i.e. block 92).

In an embodiment, the transaction information includes an Application Transaction Counter (ATC) and an Unpredictable Number (UN) and the first and second authentication codes are dCVC3 codes. Accordingly, generating the first authentication code from the transaction information and the first cryptographic key involves generating a dCVC3 code as defined with reference to the dCVC3 standard documentation. Additionally, generating the second authentication code from the transaction information and the second cryptographic key involves generating a dCVC3 code as defined with reference to the dCVC3 standard documentation.

As mentioned above, the devices and servers of the above-described embodiments may be a computer system. Additionally, the servers of the above-described embodiments may be a plurality of interconnected computer systems. In this way, each server or device may be provided by a single physical apparatus or may be distributed across a number of different physical apparatuses, perhaps in different geographical locations. An exemplary computer system is described below with reference to FIG. 6.

FIG. 6 depicts an example computing device 1000. The following description of the computing device 1000 is provided by way of example only and is not intended to be limiting.

The example computing device 1000 includes a processor 1004 for executing software routines. Although a single processor is shown for the sake of clarity, the computing device 1000 may also include a multi-processor system. The processor 1004 is connected to a communication infrastructure 1006 for communication with other components of the computing device 1000. The communication infrastructure 1006 may include, for example, a communications bus, cross-bar, or network.

The computing device 1000 further includes a main memory 1008, such as a random access memory (RAM), and a secondary memory 1010. The secondary memory 1010 may include, for example, a hard disk drive 1012 and/or a removable storage drive 1014, which may include a floppy disk drive, a magnetic tape drive, an optical disk drive, or the like. The removable storage drive 1014 reads from and/or writes to a removable storage unit 1018 in a well-known manner. The removable storage unit 1018 may include a floppy disk, magnetic tape, optical disk, or the like, which is read by and written to by removable storage drive 1014. As will be appreciated by persons skilled in the relevant art(s), the removable storage unit 1018 includes a computer readable storage medium having stored therein computer executable program code instructions and/or data.

In an alternative implementation, the secondary memory 1010 may additionally or alternatively include other similar means for allowing computer programs or other instructions to be loaded into the computing device 1000. Such means can include, for example, a removable storage unit 1022 and an interface 1020. Examples of a removable storage unit 1022 and interface 1020 include a program cartridge and cartridge interface (such as that found in video game console devices), a removable memory chip (such as an EPROM or PROM) and associated socket, and other removable storage units 1022 and interfaces 1020 which allow software and data to be transferred from the removable storage unit 1022 to the computer system 1000.

The computing device 1000 also includes at least one communication interface 1024. The communication interface 1024 allows software and data to be transferred between computing device 1000 and external devices via a communication path 1026. In various embodiments, the communication interface 1024 permits data to be transferred between the computing device 1000 and a data communication network, such as a public data or private data communication network. The communication interface 1024 may be used to exchange data between a plurality of different computing devices 1000 that together form an interconnected computer network. Examples of a communication interface 1024 can include a modem, a network interface (such as an Ethernet card), a communication port, an antenna with associated circuitry and the like. The communication interface 1024 may be wired or may be wireless. Software and data transferred via the communication interface 1024 are in the form of signals which can be electronic, electromagnetic, optical or other signals capable of being received by communication interface 1024. These signals are provided to the communication interface via the communication path 1026.

As shown in FIG. 6, the computing device 1000 further includes a display interface 1002 which performs operations for rendering images to an associated display 1030 and an audio interface 1032 for performing operations for playing audio content via associated speaker(s) 1034.

As used herein, the term “computer program product” may refer, in part, to removable storage unit 1018, removable storage unit 1022, a hard disk installed in hard disk drive 1012, or a carrier wave carrying software over communication path 1026 (wireless link or cable) to communication interface 1024. A computer readable medium can include magnetic media, optical media, or other recordable media, or media that transmits a carrier wave or other signal. These computer program products are devices for providing software to the computing device 1000.

The computer programs (also called computer program code) are stored in main memory 1008 and/or secondary memory 1010. Computer programs can also be received via the communication interface 1024. Such computer programs, when executed, enable the computing device 1000 to perform one or more features of embodiments discussed herein. In various embodiments, the computer programs, when executed, enable the processor 1004 to perform features of the above-described embodiments. Accordingly, such computer programs represent controllers of the computer system 1000.

Software may be stored in a computer program product and loaded into the computing device 1000 using the removable storage drive 1014, the hard disk drive 1012, or the interface 1020. Alternatively, the computer program product may be downloaded to the computer system 1000 over the communications path 1026. The software, when executed by the processor 1004, causes the computing device 1000 to perform functions of embodiments described herein.

It is to be understood that the embodiment of FIG. 6 is presented merely by way of example. Therefore, in some embodiments one or more features of the computing device 1000 may be omitted. Also, in some embodiments, one or more features of the computing device 1000 may be combined together. Additionally, in some embodiments, one or more features of the computing device 1000 may be split into one or more component parts.

It will be appreciated that the elements illustrated in FIG. 6 function to provide means for performing the various functions and operations of the servers as described in the above embodiments.

The devices of the above-described embodiments may be a wireless computing device. An example wireless computing device is described below with respect to FIG. 7.

FIG. 7 is a schematic of an example wireless computing device 1100. The following description of the wireless computing device 1100 is provided by way of example only and is not intended to be limiting.

The wireless device 1100 comprises a keypad 1102, a touch-screen 1104, a microphone 1106, a speaker 1108 and an antenna 1110. The wireless device 1100 is capable of being operated by a user to perform a variety of different functions, such as, for example, hosting a telephone call, sending an SMS message, browsing the Internet, sending an email and providing satellite navigation.

The wireless device 1100 comprises hardware to perform communication functions (e.g. telephony, data communication), together with an application processor and corresponding support hardware to enable the wireless device 1100 to have other functions, such as, messaging, Internet browsing, email functions and the like. The communication hardware is represented by the RF processor 1112 which provides an RF signal to the antenna 1110 for the transmission of data signals, and the receipt therefrom. Additionally provided is a baseband processor 1114, which provides signals to and receives signals from the RF Processor 1112. The baseband processor 1114 also interacts with a subscriber identity module 1116, as is well known in the art. The communication subsystem enables the wireless device 1100 to communicate via a number of different communication protocols including 3G, 4G, GSM, WiFi, Bluetooth™ and/or CDMA. The communication subsystem of the wireless device 900 is beyond the scope of the present invention.

The keypad 1102 and the touch-screen 1104 are controlled by an application processor 1118. A power and audio controller 1120 is provided to supply power from a battery 1122 to the communication subsystem, the application processor 1118, and the other hardware. The power and audio controller 1120 also controls input from the microphone 1106, and audio output via the speaker 1108. Also provided is a global positioning system (GPS) antenna and associated receiver element 1124 which is controlled by the application processor 1118 and is capable of receiving a GPS signal for use with a satellite navigation functionality of the wireless device 1100.

In order for the application processor 1118 to operate, various different types of memory are provided. Firstly, the wireless device 1100 includes Random Access Memory (RAM) 1126 connected to the application processor 1118 into which data and program code can be written and read from at will. Code placed anywhere in RAM 1126 can be executed by the application processor 1118 from the RAM 1126. RAM 1126 represents a volatile memory of the wireless device 1100.

Secondly, the wireless device 1100 is provided with a long-term storage 1128 connected to the application processor 1118. The long-term storage 1128 comprises three partitions, an operating system (OS) partition 930, a system partition 1132 and a user partition 1134 The long-term storage 1128 represents a non-volatile memory of the wireless device 1100.

In the present example, the OS partition 1130 contains the firmware of the wireless device 1100 which includes an operating system. Other computer programs may also be stored on the long-term storage 1128, such as application programs, and the like. In particular, application programs which are mandatory to the wireless device 1100, such as, in the case of a smartphone, communications applications and the like are typically stored in the system partition 1132. The application programs stored on the system partition 1132 would typically be those which are bundled with the wireless device 1100 by the device manufacturer when the wireless device 1100 is first sold.

Application programs which are added to the wireless device 1100 by the user would usually be stored in the user partition 1134.

As stated, the representation of FIG. 7 is schematic. In practice, the various functional components illustrated may be substituted into one and the same component. For example, the long-term storage 1128 may comprise NAND flash, NOR flash, a hard disk drive or a combination of these. Additionally, one or more components may be omitted.

It is to be understood that the devices and servers of any one of the above-described embodiments may be generally described as a physical apparatus including at least one processor and at least one memory having computer program code. The at least one memory and the computer program code are configured to, with the at least one processor, cause the physical apparatus to perform the above-described operations of an embodiment. This general description also provides a general description of the example computer system of FIG. 6 and the example wireless device of FIG. 7.

It will be appreciated by a person skilled in the art that numerous variations and/or modifications may be made to one or more of the above-described embodiments without departing from the spirit or scope of the invention as broadly described in the appended claims. The above-described embodiments are, therefore, to be considered in all respects to be illustrative and not restrictive.

What is claimed is:

1. A method for authenticating a transaction, the method comprising:
generating a first authentication code based on transaction information and a first cryptographic key, the transaction information relating to the transaction;
providing a data carrier having data comprising the first authentication code and the transaction information;
presenting the data carrier to a first server to cause the first server to extract the data from the data carrier;
generating a second authentication code based on a second cryptographic key and the transaction information from the extracted data; and
authenticating the transaction based on a comparison between the first authentication code from the extracted data and the second authentication code.

2. The method of claim 1, wherein the first server is associated with a first party to the transaction and the first server generates the first authentication code and provides the data carrier to a second party to the transaction, and the second party presents the data carrier to the first server.

3. The method of claim 2, wherein the data further comprises a transaction amount being an amount received for the transaction by the first party from the second party; and
wherein the method further comprises: authorizing the transaction based on a comparison between the transaction amount from the extracted data and a transaction charge associated with the transaction.

4. The method of claim 3, wherein the first authentication code is generated based on the transaction amount and the second authentication code is generated based on the transaction amount from the extracted data.

5. The method of claim 3, wherein the first server performs the steps of generating the second authentication code, authenticating the transaction and/or authorizing the transaction.

6. The method of claim 3, further comprising sending the extracted data from the first server to an authentication server, and wherein the authentication server performs the steps of generating the second authentication code, authenticating the transaction and/or authorizing the transaction.

7. The method of claim 1, wherein the first server is associated with a first party to the transaction and the first authentication code is generated by a device associated with a second party to the transaction, and wherein the device provides the data carrier and presents the data carrier to the first server.

8. The method of claim 7, wherein the data further comprises a transaction charge and account information, the transaction charge being a charge associated with the transaction, the account information identifying an account for use in the transaction; and
wherein the method further comprises: determining an amount of available credit in the account using the account information from the extracted data; and authorizing the transaction based on a comparison between the determined amount of available credit and the transaction charge from the extracted data.

9. The method of claim 8, wherein the first authentication code is generated based on the transaction charge and the account information, and the second authentication code is generated based on the transaction charge from the extracted data and the account information from the extracted data.

10. The method of claim 8, wherein authorizing the transaction comprises releasing funds from the account, the funds being equal to the transaction charge from the extracted data.

11. The method of claim 8, further comprising sending the extracted data from the first server to an issuer server associated with an issuer of the account, and wherein the issuer server performs the steps of generating the second authentication code, authenticating the transaction, determining the amount of available credit and authorizing the transaction.

12. The method of claim 1, wherein the data carrier is a graphical representation of the data, and wherein presenting the data carrier to the first server comprises:
presenting the graphical representation to a scanning device of the first server;
detecting the presented graphical representation at the scanning device; and
extracting the data from the detected graphical representation by the scanning device.

13. The method of claim 12, wherein the graphical representation is a Quick Response (QR) code or a barcode.

14. The method of any one of claim 1, wherein the data carrier is an apparatus with a computer-readable storage medium having stored thereon the data, and wherein presenting the data carrier to the first server comprises:
presenting the apparatus to a reading device of the first server to establish communication between the apparatus and the reading device; and
extracting the data from the computer-readable storage medium by the reading device.

15. The method of claim 14, wherein the apparatus is a wireless computing device or a payment card having a magnetic stripe and/or an radio-frequency identification (RFID) microchip and antenna.

16. The method of claim 1, wherein the first and second cryptographic keys are identical.

17. The method of claim 1, wherein the transaction is authenticated if the first authentication code from the extracted data corresponds with or matches the second authentication code.

18. The method of claim 1, wherein the transaction information comprises an application transaction counter (ATC) and an unpredictable code (UN) and the first and second authentication codes are dynamic card validation codes (dCVC3).

19. A server for authenticating a transaction, the server being associated with a first party to the transaction, the server comprising:
at least one processor;
and at least one memory including computer program code;
the at least one memory and the computer program code configured to, with the at least one processor, cause the server at least to:
generate a first authentication code based on transaction information and a first cryptographic key, the transaction information relating to the transaction;
provide a data carrier having data comprising the first authentication code and the transaction information to a second party to the transaction;
extract the data from the data carrier when the second party presents the data carrier to the server;
generate a second authentication code based on a second cryptographic key and the transaction information from the extracted data; and
authenticate the transaction based on a comparison between the second authentication code and the first authentication code from the extracted data.

20. The server of claim 19, wherein the data further comprises a transaction amount being an amount received for the transaction by the first party from the second party; and
wherein the at least one memory and the computer program code are configured to, with the at least one processor, further cause the server at least to: authorize the transaction based on a comparison between the transaction amount from the extracted data and a transaction charge associated with the transaction.

21. The server of claim 20, wherein the first authentication code is generated based on the transaction amount and the second authentication code is generated based on the transaction amount from the extracted data.

22. The server of claim 19, wherein the data carrier is an apparatus with a computer-readable storage medium having stored thereon the data and the server further comprises a reader, and wherein the second party presents the apparatus to the reader to present the data carrier to the server, the reader being configured in use to establish communication with the presented apparatus and extract the data from the computer-readable storage medium.

23. The server of claim 22, wherein the apparatus is a wireless computing device, a cellular phone or a payment card having an radio-frequency identification (RFID) microchip and antenna.

24. The server of claim 19, wherein the data carrier is a graphical representation of the data and the server further comprises a scanner, and wherein the second party presents the graphical representation to the scanner to present the data carrier to the server, the scanner being configured in use to detect the presented graphical representation and extract the data therefrom.

25. The server of claim 24, wherein the graphical representation is a Quick Response (QR) code or a barcode.

26. The server of claim 19, wherein the first and second cryptographic keys are identical.

27. The server of claim 19, wherein the transaction is authenticated if the first authentication code from the extracted data corresponds with or matches the second authentication code.

28. The server of claim 19, wherein the transaction information comprises an application transaction counter (ATC) and an unpredictable code (UN) and the first and second authentication codes are dynamic card validation codes (dCVC3).

29. A device for use in a system for authenticating a transaction, the device being associated with a second party to the transaction, the device comprising:
at least one processor;
and at least one memory including computer program code;
the at least one memory and the computer program code configured to, with the at least one processor, cause the device at least to:
generate a first authentication code based on transaction information and a first cryptographic key, the transaction information relating to the transaction;
provide a data carrier having data comprising the first authentication code and the transaction information;
present the data carrier to a first server, the first server being associated with a first party to the transaction.

30. A first server for use in a system for authenticating a transaction, the first server being associated with a first party to the transaction, the first server comprising:
at least one processor;
and at least one memory including computer program code;
the at least one memory and the computer program code configured to, with the at least one processor, cause the first server at least to:
extract data from a data carrier when a second party to the transaction presents the data carrier to the first server, the data comprising a first authentication code and transaction information, the transaction information relating to the transaction; and
send the extracted data to an issuer server.

31. An issuer server for use in a system for authenticating a transaction, the issuer server comprising:
at least one processor;
and at least one memory including computer program code;
the at least one memory and the computer program code configured to, with the at least one processor, cause the issuer server at least to:
receive extracted data from a first server, the extracted data comprising a first authentication code and transaction information, the transaction information relating to the transaction;
generate a second authentication code based on a second cryptographic key and the transaction information from the extracted data; and
authenticate the transaction based on a comparison between the second authentication code and the first authentication code from the extracted data.

32. A system for authenticating a transaction, the system comprising:
a first server;
an issuer server; and
a device associated with a second party to the transaction, the device in turn comprising:
at least one device processor; and
at least one device memory including device computer program code;
the at least one device memory and the device computer program code configured to, with the at least one device processor, cause the device at least to:
generate a first authentication code based on transaction information and a first cryptographic key, the transaction information relating to the transaction;
provide a data carrier having data comprising the first authentication code and the transaction information;
present the data carrier to the first server, the first server being associated with a first party to the transaction;
the first server in turn comprising:
at least one first server processor; and
at least one first server memory including first server computer program code;
the at least one first server memory and the first server computer program code configured to, with the at least one first server processor, cause the first server at least to:
extract data from the data carrier when the second party to the transaction presents the data carrier to the first server; and
send the extracted data to the issuer server; and
the issuer server in turn comprising:
at least one issuer server processor; and
at least one issuer server memory including issuer server computer program code;
the at least one issuer server memory and the issuer server computer program code configured to, with the at least one issuer server processor, cause the issuer server at least to:
receive extracted data from the first server, the extracted data comprising a first authentication code and transaction information, the transaction information relating to the transaction;
generate a second authentication code based on a second cryptographic key and the transaction information from the extracted data; and
authenticate the transaction based on a comparison between the second authentication code and the first authentication code from the extracted data.

33. The system of claim 32, wherein the data on the data carrier provided by the device, the data on the data carrier presented to the first server and the data received by the issuer server further comprises a transaction charge and account information, the transaction charge being a charge associated with the transaction, the account information identifying an account for use in the transaction;
wherein the issuer server is further caused to: determine an amount of available credit in the account using the account information from the extracted data; and
authorize the transaction based on a comparison between the determined amount of available credit and the transaction charge from the extracted data.

34. The system of claim 33, wherein the first authentication code is generated based on the transaction charge and the account information, and the second authentication code is generated based on the transaction charge from the extracted data and the account information from the extracted data.

35. The system of claim 33, wherein, when the issuer server is caused to authorize the transaction, the issuer server is configured to release funds from the account, the funds being equal to the transaction charge from the extracted data.

36. The system of claim 32, wherein the data carrier is a graphical representation of the data and the first server further comprises a scanner, and wherein the device presents the graphical representation to the scanner to present the data carrier to the first server, the scanner being configured in use to detect the presented graphical representation and extract the data therefrom.

37. The system of claim 36, wherein the graphical representation is a Quick Response (QR) code or a barcode.

38. The system of claim 32, wherein the first and second cryptographic keys are identical.

39. The system of claim 32, wherein the transaction is authenticated if the first authentication code from the extracted data corresponds with or matches the second authentication code.

40. The system of claim 32, wherein the transaction information comprises an application transaction counter (ATC) and an unpredictable code (UN) and the first and second authentication codes are dynamic card validation codes (dCVC3).

41. A non-transitory computer readable medium comprising computer executable instructions which when executed by a computer cause the computer to perform a method for authenticating a transaction, the method comprising:
generating a first authentication code based on transaction information and a first cryptographic key, the transaction information relating to the transaction;
providing a data carrier having data comprising the first authentication code and the transaction information;
presenting the data carrier to a first server to cause the first server to extract the data from the data carrier;
generating a second authentication code based on a second cryptographic key and the transaction information from the extracted data; and
authenticating the transaction based on a comparison between the first authentication code from the extracted data and the second authentication code.
